(19) United States
(12) Patent Application Publication
(10) Pub. No.: US 2013/0097648 A1
(43) Pub. Date: Apr. 18, 2013

(54) INTERNET-ENABLED SMART TELEVISION

(71) Applicants: Zhou Ye, Foster City, CA (US); Pei-Chuan Liu, Taipei City (TW)

(72) Inventors: Zhou Ye, Foster City, CA (US); Pei-Chuan Liu, Taipei City (TW)

(73) Assignee: BLUESPACE CORPORATION, APIA (WS)

(21) Appl. No.: 13/353,307

(22) Filed: Jan. 18, 2012

(30) Foreign Application Priority Data
Oct. 18, 2011 (CN) 201110317062.1

(51) Int. Cl. H04N 21/643

(52) U.S. Cl. 725/110

(57) ABSTRACT

A smart TV is adapted to establish a wireless local area network, and can use wireless local area network to be communicatively connected with one or more wireless internet device. The smart TV includes at least one tuner, a wireless network module, and a codec. Tuner is used for receiving TV signals, the wireless network module is used for transmitting wireless network signals for establishing wireless local area network, and wireless network module can discriminate between types of wireless internet device. Input end of codec is electrically coupled to tuner, and output end of codec is electrically coupled to wireless network module, in which codec performs an encoding function of the television signals according to type of wireless internet device to generate at least one encoded signal. Wireless network module receives encode signals transmitted from tuner, and transmits encoded signal to the wireless internet device.

### BACKGROUND OF THE INVENTION

1. Technical Field

The present invention relates to a television, and more particularly, to a smart television (Smart TV) having internet or network connectivity capability with one or more wireless internet devices.

2. Description of Related Art

In recent years, technological advancements for smart phones or tablet computers have dramatically accelerated, thereby leading to more and more users of such wireless device. With the rapid progress of the wireless telecommunication technology, there are more and more users using smart phones or tablet computers (tablet PCs) for wireless internet accesses. Compared to wired internet systems, smart phones or tablet PCs would provide the user a higher degree of comfort and usage convenience when used for wireless Internet access. In addition, smart phones and tablet PCs with their continuous dropping in prices are increasingly becoming cheaper and also more powerful, thereby more and more families possess both more than one smart phone or tablet PC. As a result, whenever a family requires internet access, they would just need to set up a wireless internet sharing device (a wireless router, for example), and it will also allow more family members to enjoy wireless Internet access all at the same time, as well as allowing file sharing capability among each other.

Besides, with the improving of living standard, people have more choices in entertainment options, but even so, watching television continues to occupy much of people's leisure time. There are two common received television signal types, namely, analog TV (Analog Television) and digital TV (Digital Television). The analog TV receives a plurality of analog TV signals, and the digital TV receives a plurality of digital TV signals. When the television stations are transmitting their respective television signals, they will first convert the analog TV signals in the form of text, images, sound, and video into digital TV signals and then are compressed before transmission to digital TV. Later, the digital television decoder takes the received digital TV signals to perform decoding, and then provides playback of the TV programming.

However, in the current market, most of the smart phones or tablet computers cannot directly receive the television signals (regardless of whether analog or digital TV signals), for example, Apple iPhone (smartphone) and iPad (tablet computer) do not support the MPEG-2 digital format. Therefore, whenever the smartphone or tablet PC users want to watch any TV programs, they must use conventional TV set to watch such TV programs; therefore, they cannot directly use any smart phone or tablet computer to watch such TV programs. Since the weight of the TV set is relatively heavy and that the volume thereof is also very large, it is often found that the TV set is disposed at a fixed location, and not as easily carried or portable as the smart phones or tablet computers would be to the users.

Therefore, it is found that there is room for improvement within the art for allowing smart phones and tablet computers to have wireless Internet access to watch television programs, and such effort is worthy of attention.

### SUMMARY OF THE INVENTION

An object of the present invention is to provide a smart television that is configured to provide a wireless local area network and enable wireless portable or mobile internet devices such as smart phones and tablet computers, to watch television programs.

According to the above object and other objects, a smart television is provided in the present invention. The smart TV is configured to establish a wireless local area network, and the smart TV through the corresponding wireless local area network can provide wireless connectivity between one or more wireless internet devices and the smart TV, wherein the smart TV includes at least one tuner (TV tuner), a wireless network module, and a codec. The tuner is configured to set up a wireless local area network. In addition, the input end of the codec is electrically connected to the tuner, and the output end of the codec is electrically connected to the wireless network module. The codec is used for encoding the at least one television signals to form at least one encoded signal. The wireless network module receives the encoded signals transmitted from the codec, and transmits the at least one encoded signalto at least one wireless internet device.

According to an aspect of the instant disclosure, the wireless network module is a Wi-Fi module or a WiMAX module.

The Smart TV, according to an embodiment of present invention, also includes a controller, and the controller is connected between the wireless network module (or wireless internet module) and the codec. Through the wireless network module, one or more wireless Internet devices can transmit a control command to the controller. The corresponding control command indicates a plurality of selection information for TV frequency channel and the type of encoding signal compatible to the corresponding wireless internet device. Moreover, the codec encodes the at least one TV signal to form the at least one encoded signal according to the type of the wireless Internet device.

In the aforementioned smart TV, the controller automatically adjusts the resolution of the at least one encoded signal based on the signal quality of the wireless local area network.

In the aforementioned smart TV, the television signal may include one or more analog TV signals.

In the aforementioned smart TV, the television signal may include one or more digital TV signals, wherein the codec is configured to perform decoding upon the television signal to form a decoded signal. In addition, the smart television is configured to convert the decoded signal to at least one digital image and to be displayed on a display screen of the smart television.

In the aforementioned smart TV, the quantity of the wireless internet devices can be greater than one, and the wireless internet device can be of more than one type, and the encoder is to produce a plurality of sets of encoded signals according to the various types of the corresponding wireless internet devices.

In the aforementioned smart TV, the smart television is configured to turn off a display device of the smart television when the smart television remains in an operating mode.

In the aforementioned smart TV, the wireless internet device is a smartphone, a tablet computer, or a notebook computer.

In the aforementioned smart TV, the codec is configured to perform encoding of the television signal according to the type of the wireless internet device, and using the wireless network module to transmit the encoded signal to the wireless internet device configured within the wireless LAN, thereby allowing users of wireless internet devices to watch television programs without having or requiring direct accesses to television signals.

Moreover, energy saving is realized for the aforementioned smart TV. For example, when a display device of the smart television is configured to be turned off during which the smart television is remained turned on; while other wireless internet devices are also in operating mode when the display device of the smart TV is turned off.

These and other features of the present invention will become readily apparent upon further review of the following specification and drawings.

The components in the drawings are not necessarily drawn to scale, the emphasis instead placed upon clearly illustrating the principles of the present disclosure. Moreover, in the drawings, like reference numerals designate corresponding parts throughout the several views.

### BRIEF DESCRIPTION OF THE DRAWINGS

FIG. 1 shows a smart TV according to a first embodiment of the present invention.

FIG. 2 shows a block diagram of the smart TV of the first embodiment.

FIG. 3 shows a flowchart illustrating how to build up the wireless interconnectivity between the wireless internet devices and the smart TV.

FIG. 4 shows a block diagram of the smart TV according to a second embodiment of the present invention.

### DETAILED DESCRIPTION OF THE INVENTION

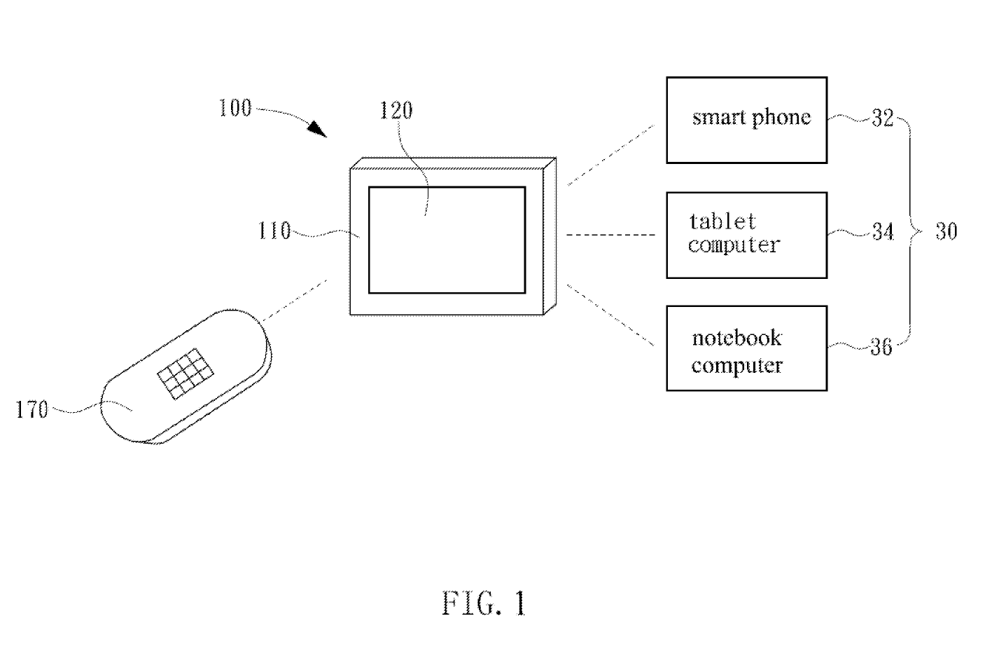

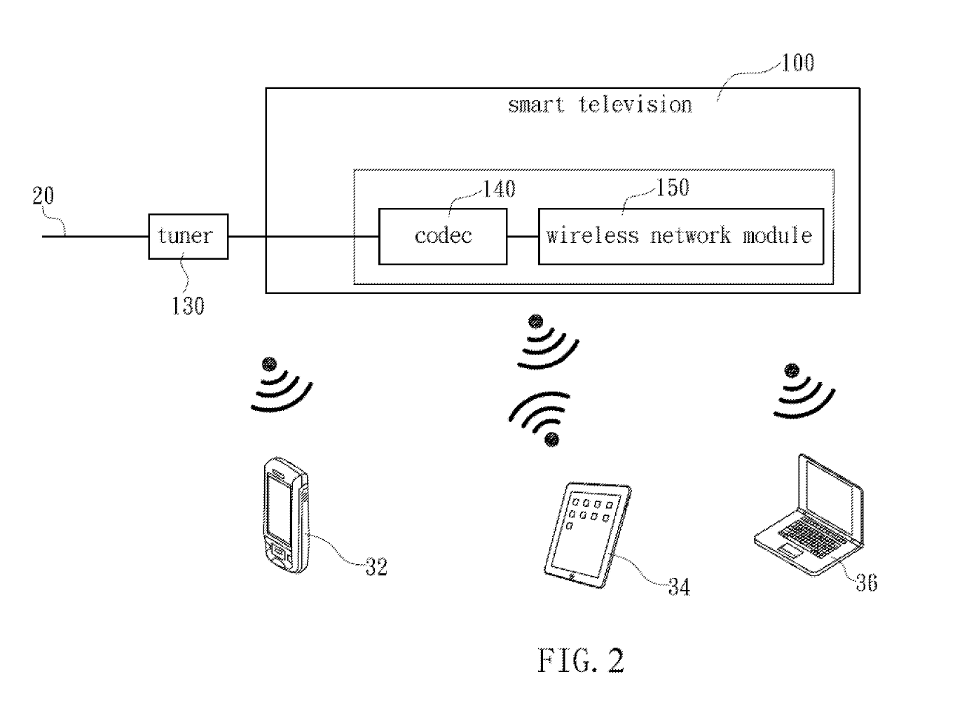

Refer to FIGS. 1 and 2, a smart TV 100 according to a first embodiment of the present invention is illustrated, and a block diagram showing the general configuration of the smart TV 100 of the first embodiment is also presented. In the first embodiment, the smart TV 100 includes, but is not limited to, a housing 110, a display device 120, a tuner 130, a codec 140, a wireless network module 150, and a remote controller 170. The display device 120 is located in the housing 110, and can be, for example, an LCD display, a plasma display panel, or an organic light-emitting diode display. In addition, the user of the Smart TV 100 can readily select desired television channels or programs via the remote controller 170.

Referring again to FIGS. 1 and 2, the tuner 130 is externally connected to a transmission line 20, the transmission line 20 is adapted to transmit analog or digital TV signals broadcasted from the TV stations. The tuner 130 receives TV signals broadcasted from the TV stations, in which the TV signal operates in a high-frequency band of 200˜800 MHz, and is down-converted to about 36 MHz in the IF frequency range, and then sent to the codec 140. The codec 140 is electrically connected to the tuner 130, wherein when the TV signal is transmitted under digital television signal format, the codec 140 can decode the digital TV signals in order to convert the TV signal into a decoded signal (for example, decompression). This decoded signal is then transmitted to a video scaler, and this video scaler (converter) is used to adjust the resolution, so that the video images can be properly displayed in the respective display area on the display device 120. When the tuner 130 transmits analog television signals, the codec 140 can transmit directly the television signals to the video scaler, such that the video image can be displayed in the display area on the display device 120.

In addition, apart from being able to perform decoding, the codec 140 can also perform encoding, and can also use encoded signal or analog TV signal to perform encoding to form an encoded signal, such as a video stream. Since the wireless network module 150 and the codec 140 are electrically connected to each other, the encoded signal can be transmitted to the wireless network module 150.

In addition, in this embodiment, the wireless network module 150 is consistent with IEEE 802.11 protocol, which means that the wireless network module 150 is a WiFi module. Certainly, the wireless network module 150 can also be configured for other wireless communication protocols, such as, WiMAX. Please note that the wireless network module 150 may be implemented by a WiFi or WiMAX module, but it is to be understood that the present invention is not limited to these precise embodiments, and that various changes and modifications may be effected without departing from the spirit of the invention, and therefore any wireless communication protocol that can be used for setting up a wireless local area network would also fall into the scope of the present invention.

In addition, the wireless network module 150 can send out a wireless network signal, and thus a wireless local area network can be established within a certain region, and a plurality of wireless internet devices 30 located within the wireless local area network can perform data transmission with the smart TV 100. Therefore, the encoded signals produced from the codec 140 can be transmitted by the wireless network module 150 to the wireless internet devices 30. In this embodiment, the wireless internet device 30 includes a smart phone 32, a tablet computer 34, and a notebook computer 36. In other embodiments, the wireless internet device 30 can also be a digital camera, a personal computer, another smart television, or other wireless network electronic devices.

In addition, in a preferred embodiment, the smart television 100 can also be configured to identify a variety of types of wireless internet devices 30 within the wireless local area network, that is, the smart television 100 can intercept packets transmitted between the wireless network module 30 and the wireless network module 150 packets to identify the supported codecs of the wireless internet device 30. Therefore, the codec 140 can perform encoding functions according to the type of the wireless internet device 30 identified by the wireless network module 150. Referring to FIG. 2, tablet computer 34, such as an Apple iPad, and the codec 140 can end the decoded signals to generate encoded signals compliant with the H.264 format, so that the encoded signals can be read by the tablet computer 34.

As the wireless Internet device 30 can read encoded signals, the user can use the wireless internet device 30 to watch various television programs as long as the wireless internet device 30 is located inside the wireless local area network established or set up by the wireless network module 150 even if the wireless internet device 30 cannot read the TV signal directly. Moreover, if each of the wireless internet device 30 support a different audio and video playback format, the codec 140 may also be configured to match the particular type of audio and audio playback format of the wireless internet device 30 to form a plurality of different sets of encoded signals. For example, if one tablet computer 34 can read only the H.264 encoded signals and one smart phone 32 can read the RMVB format encoded signals, the codec 140 can then perform encoding to form two sets of encoding signals, that is, one for the H.264 format, and another for the RMVB format, and uses the wireless network module 150 to encode signals to the tablet computer 34 and the smart phones 32.

In addition, the users of the wireless internet access device 30 can also upload streaming data to the smart TV 100. For example, the users can upload streaming audio and video data from stored audio and video on the smartphone 32 to the smart TV 100 for playback. If the display device 120 cannot directly read this streaming data, the codec 140 may also encode the streaming data into a readable streaming data compatible with the display device 120. As a result, the user will be able to watch audio and video playback in a larger display screen. In addition, if the Smart TV 100 also includes a hard disk (not shown), the user of the wireless internet device 30 can upload files thereof to the hard disk residing in the smart TV 100.

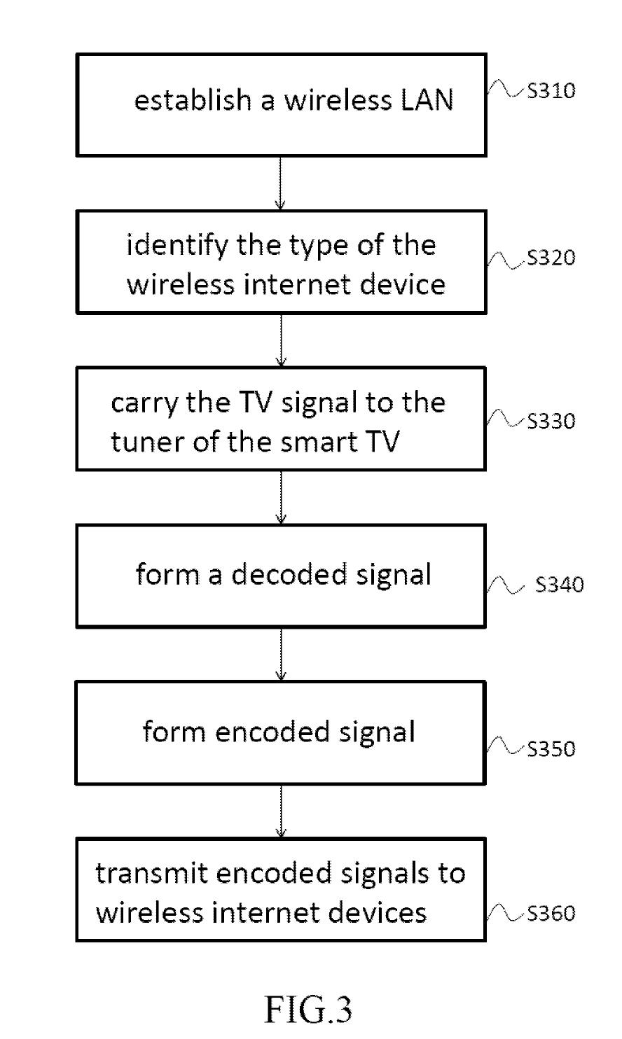

Referring to FIG. 3, a flowchart showing a process how to build up a the wireless interconnectivity between the wireless internet devices 30 and the smart TV 100 is provided, which illustrates how the user is able to watch TV using the wireless internet device 30 through the smart TV 100 of the present embodiment. First, in step S310, by using the wireless network signals broadcasted from the wireless network module 150 of the smart TV 100, a particular specified region is established to be a wireless local area network, in which the wireless internet device 30 can be implemented by members within this wireless local area network, and to be interconnected to the smart TV 100 for wireless data transmission. In step S320, a wireless network module 150 is used to identify the type of the wireless internet device 30. In step S330, the transmission line 20 carries the TV signal (in this embodiment, the TV signal is a plurality of digital television signals) to the tuner 130 of the smart TV 100. Later, after the tuner 130 performs a down-conversion on the TV signal, the TV signal is then sent to the codec 140. Afterwards, in step S340, the codec 140 decodes the TV signals to generate a decoded signal

After that, please refer to step S350, the codec 140 performs an encoding function on the decoded signals according to the type of the wireless internet device 30 so as to generate the at least one encoded signal readable to the wireless internet device 30. For example, the tablet computer 34 is an iPad as shown in FIG. 2, the codec 140 can perform an encoding function on the decode signals to generate a plurality of encoded signals compliant with the H.264 format, thereby allowing the compatible encoded signals to be read by the tablet computer 34.

In step S360, the encoded signal is broadcasted to a wireless internet device 30 through the wireless network module 150, the encoded signal is of a compatible readable format for the wireless internet device 30, therefore allowing the users to watch TV programs on the wireless internet device 30. In the above embodiment, the smart TV 100 is only equipped with one tuner 130, so that the wireless interne device 30 cannot independently select a different TV channel to be watched (a channel that is different from the channel being selected on the smart TV 100 itself) but must share the same channel to be viewed as on the smart TV 100 itself. However, those skilled in the art may add more tuners 130 into one smart TV, so as to permit the user of the wireless Internet device 30 to have channel selection independence or freedom, and that the user can independently select another channel, and one embodiment will be described below.

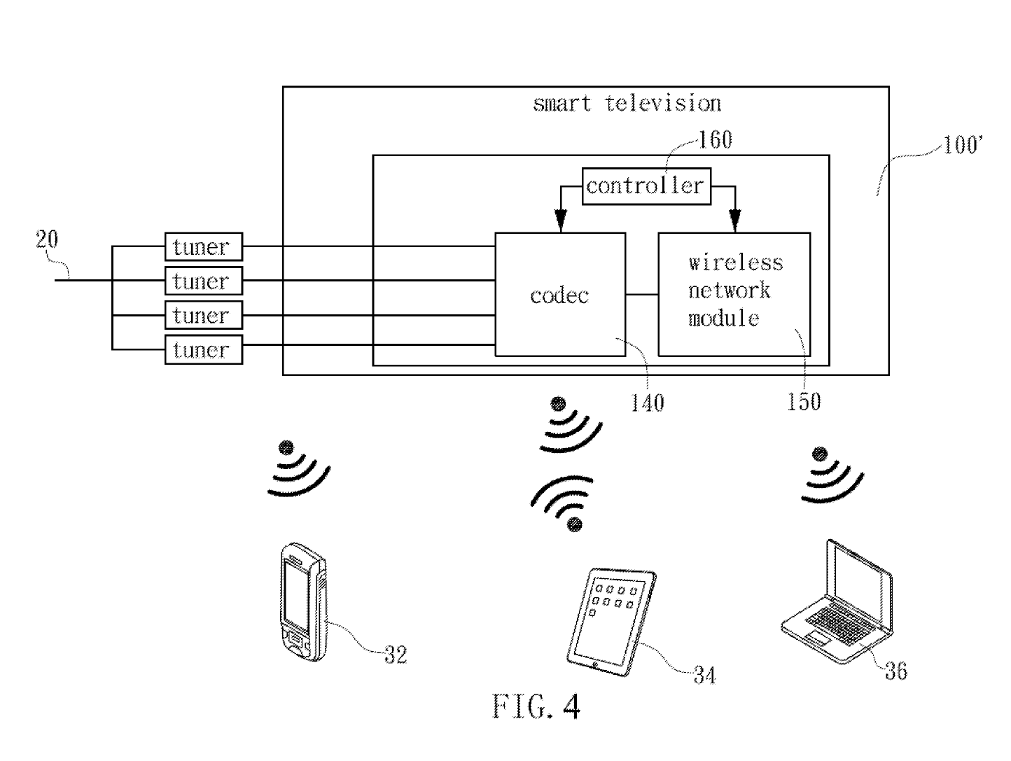

Refer to FIG. 4, a block diagram of the smart TV according to the second embodiment of the present invention is shown. Compared to the first embodiment, the second embodiment of the Smart TV 100′ also includes a controller 160, which resides between the codec 140 and the wireless network module 150. The user of the wireless internet device 30 located in the wireless local area network can launch or actuate a control command to the smart TV 100′, and the wireless network module 150 receives the control command and then sends the control command to the controller 160. In accordance with the control command, the controller controls the codec 140, that is to say, any wireless internet device 30 can be used as a TV remote controller for the smart TV 100. In actual implementation, the tablet computer 34 can be used as the TV remote controller for the smart TV 100, or the tablet computer 34 can also be used to control the operating state and display statuses of other wireless internet devices 30 (the smart phones 32 and the notebook computers 36) to achieve multi-screen interactive effects.

The control commands described above may include channel selection, in which the user can, for example, choose own personal favorite channel to be watched on the wireless internet device 30. Moreover, in another embodiment, the tuner 130 can be a total number of four, so that the users using the smart phones 32, the tablet computers 34, and the notebook computers 36 can individually select each of their favorite channels, without affecting the channel selection choice of the user of other wireless internet devices 30 and the smart TV 100′, respectively.

Those persons skilled in the art would appreciate as to adjust the total number of tuners 130 to be adopted according to individual preference and requirements. The more number of tuners 130 are added, more users of the wireless internet device 30 are allowed to have more channel selection independence, so that less interference to others that are using other wireless interne devices 30 would occur. Even when the display device is turned off, however, as long as the main power of the smart TV 100′ remains turned on, the tuner 130, the codec 140, and the wireless network module 150 would remain to be able to operate independently. That is to say, without having any user watching the smart TV 100′ itself, the users of the wireless internet devices 30 can remain to watch TV programs through the smart TV 100′.

In addition to having the capability for channel selection, the user of the wireless Internet device 30 can also choose the type of encoding signals using the controller 160. For example, when the wireless network signal reception condition is better, the wireless interne device 30 user can select a higher-resolution encoded signal; and when the wireless network signal reception condition is poor or worse, the user of the wireless internet device 30 can choose a lower-resolution encoded signal. Alternatively, the controller 160 may also automatically adjust the encoded signal corresponding to the resolution itself based on the wireless local area network signal quality. That is, when the wireless network signal reception condition is better, the encoded signal will be accordingly of higher resolution; and when the wireless network signal reception condition becomes worse, the encoded signals would then be accordingly of lower resolution.

Although the illustrative embodiments have been described herein with reference to the accompanying drawings, it is to be understood that the present invention is not limited to those precise embodiments, and that various changes and modifications may be effected therein by one of ordinary skill in the pertinent art without departing from the scope or spirit of the present invention. All such changes and modifications are intended to be included within the scope of the present invention as set forth in the appended claims.

What is claimed is:

1. A smart television, configured to establish a wireless local area network, the smart TV is communicatively connected to at least one wireless internet device through the wireless local area network, the smart television comprising:
at least one tuner, for receiving at least one television signal;
a wireless network module, for establishing the wireless local area network; and
a codec, an input end of the codec is electrically connected to the tuner, and an output end of the codec is electrically connected to the wireless network module for encoding the at least one television signal so as to generate at least one encoded signal, wherein the wireless network module receives the at least one encoded signal transmitted from the codec, and transmits the at least one encoded signal to the at least one wireless internet device.

2. The smart television as claimed in claim 1, wherein the wireless network module is a Wi-Fi module or a WiMAX module.

3. The smart television as claimed in claim 1, further comprising:
a controller, the controller is connected between the codec and the wireless network module, and the wireless internet device is configured to transmit one control command to the controller through the wireless network module.

4. The smart television as claimed in claim 3, wherein the control command comprises a selection of frequency channels or a type of the encoded signal, and the codec performs an encoding function on the at least one television signal to generate the at least one encoded signal according to the type of the wireless internet device.

5. The smart television as claimed in claim 3, wherein the controller automatically adjusts the resolution of the at least one encoded signal according to the signal quality of the wireless local area network signal.

6. The smart television as claimed in claim 1, wherein the television signal is an analog television signal.

7. The smart television as claimed in claim 1, wherein the television signal is a digital television signal, the codec performs a decoding function on the television signal to generate a decoded signal, the smart television is configured to convert the decoded signal to generate at least one digital image and to be displayed on a display screen of the smart television.

8. The smart television as claimed in claim 1, wherein the number and the type of the wireless internet device are greater than one, respectively, and the encoder is to produce a plurality of encoded signals corresponding to a plurality of types of wireless internet devices.

9. The smart television as claimed in claim 1, wherein the smart television is configured to turn off a display device of the smart television when the smart television is in an operating mode.

10. The smart television as claimed in claim 1, wherein the wireless internet device is a smartphone, a tablet computer, or a notebook computer.
